(19) United States
(12) Patent Application Publication
(10) Pub. No.: US 2017/0258670 A1
(43) Pub. Date: Sep. 14, 2017

(54) EXERCISER FOR REGAINING FLEXIBILITY

(71) Applicant: Ricardo Miguel Kauffmann Sommella, Zapopan (MX)

(72) Inventor: Ricardo Miguel Kauffmann Sommella, Zapopan (MX)

(21) Appl. No.: 15/329,837

(22) PCT Filed: Jul. 29, 2014
(86) PCT No.: PCT/MX2014/000120

§ 371 Date: Jan. 27, 2017

(51) Int. Cl. A61H 7/00; A61H 1/02; A63B 23/00; A61H 1/00

(52) U.S. Cl. CPC A61H 7/007; A61H 1/008; A61H 1/02; A63B 23/00; A61H 2201/1215; A61H 2203/0456; A63B 2023/006

(57) ABSTRACT

The exerciser for restoring flexibility is an electromechanical apparatus having a bed with slots on which the user lies or sits and a mechanism which, by means of high-speed rotational eccentric movements of its pegs, which are tubes having a rounded head and a flat surface that protrude through the slots of the bed, transfer the movement to the muscles of the body being targeted, thereby loosening them and consequently improving the flexibility thereof. The mechanism is mobilized by an electric motor which, by means of a belt, turns toothed pulleys, which cause eccentric shafts to rotate which, in turn, transfer that movement to bars on which a series of pins is aligned, which pins are covered by the pegs, which can be interchanged to provide different sizes and shapes, with all of them having a rounded and flat cover for adapting to the different muscles of the body and physical dimensions of the user.

### TECHNICAL FIELD

The sector of the art to which the present invention belongs is that of electromechanical exercise equipment.

### BACKGROUND

At present, humanity is suffering from a loss of flexibility, the causes of which range from stress, prolonged postures, lack of physical activity, as well as the natural chain of degeneration, which is a problem that affects the mobility of all human beings as they age. This situation leads to the emergence of numerous health problems, both in terms of physical disability and emotional distress. A flexible body is more active and remains healthy.

Various dynamic exercises exist for improving and maintaining flexibility, and numerous apparatuses for active muscle extension exercises exist as well; once stiff, however, substantial effort is required when using traditional exercises in order to regain flexibility, and it is for that reason that is not recovered in many cases.

The exerciser for restoring flexibility comprises a bed having grooves through which round-headed pegs protrude on which the user sits or lies and has contact with the pegs, with the pegs being of different sizes and shapes and being interchangeable for different positions and the anatomy of different muscles. It is an apparatus that exercises the various muscles of the body on the basis of an eccentric rotating movement, with a variable number of repetitions per minute on the part of the pegs which, upon coming into contact with the targeted muscles, achieve a normalization of the tone and progressive lengthening thereof without physical exertion, with results ranging from partial to complete depending on the condition of the muscular fibers, which are usually able to improve their flexibility, thereby enabling their range of motion to be restored.

The exerciser for restoring flexibility works by placing a muscle group over the contoured flat-headed pegs which, in turn, are inserted into pins that are supported by the bars held by the rubber supports which, in turn, are part of the containers of the rubber supports fixed to the bearing housings containing the ball bearings and, in turn, are joined by the eccentric shafts, which have a toothed pulley at the end that receives movement by means of a toothed belt and an electric motor, with this movement causing the pegs with semicircular and flat heads from the surface to come into contact with the skin and the muscles, carrying out a varied number of circular eccentric rotating movements on the muscle tissue that have proven to be effective in improving muscular extensibility, thus achieving greater flexibility and ultimately enabling physical mobility to be restored without the need for substantial physical exertion. Furthermore, as a result of the muscle relaxation, an increase in the local blood circulation in the exercised area has been observed. By virtue of the different sizes and shapes of the pegs, it is possible to adapt them to the majority of the shapes and sizes of the muscles of the body.

### BRIEF DESCRIPTION OF THE DRAWINGS

FIG. 1 shows a perspective view of the bed and its slots; the user can lie on his back or abdomen or sit on the slots through which the pegs with a rounded flat head protrude and come into contact with the muscles.

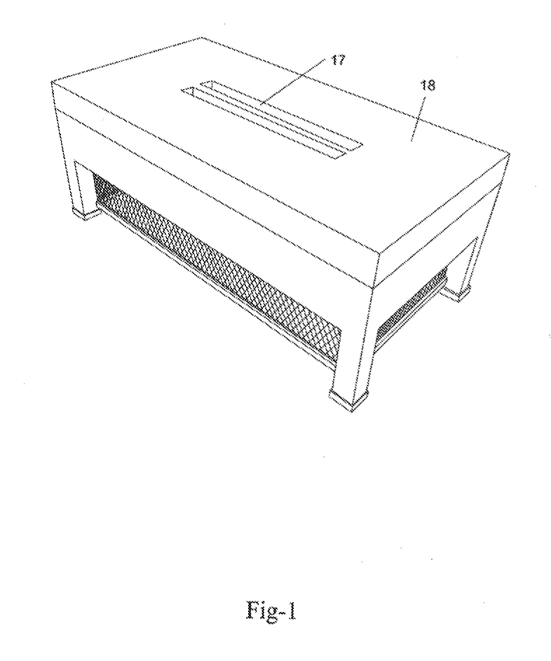

FIG. 2 shows a perspective view of the completely assembled mechanism, which is centered within the bed, with the pegs protruding through the slots.

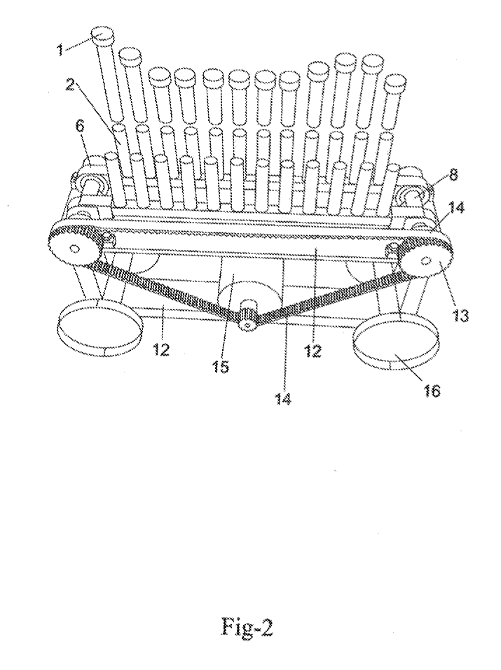

FIG. 3 shows the disassembled mechanism with all of its parts except for the base, the motor, and the toothed belt.

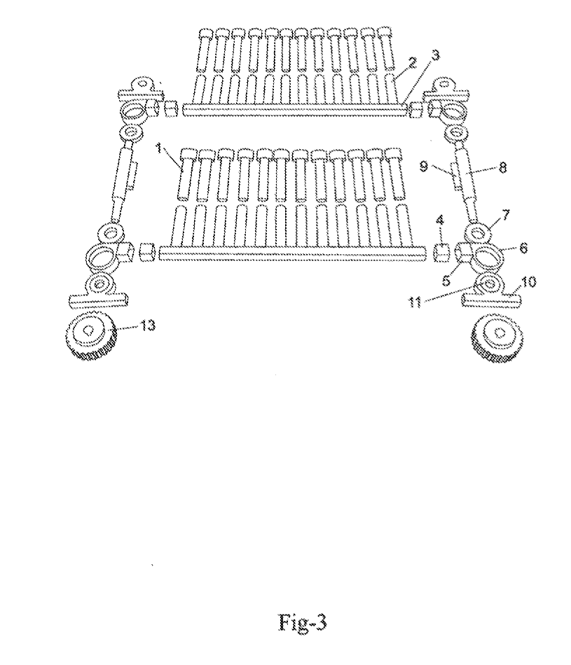

### DETAILED DESCRIPTION OF THE INVENTION

The exerciser for restoring flexibility is an apparatus that is designed to exercise numerous muscles of the body which, through the contacting by the pegs having rounded and flat heads with the targeted muscles with a continuous, eccentric, circular movement, is able to lengthen the muscle fibers without physical exertion, relaxing the muscle mass and thereby restoring the range of movement of the various joints, with the exerciser comprising a padded bed (17) with slots (18) on which the user lies or sits and a mechanism that is located within the bed with slots through which the pegs (1) having rounded and flat heads protrude, with the pegs being made of a polymeric, plastic, or metallic material and being of different sizes ranging from 5 cm to 30 cm in length and having a diameter from 5 to 30 mm and being straight or in the shape of a V or T so as to enable them to be adapted to the various muscles and sizes of user, with the pegs being inserted onto pins (2), which are made of polymer, plastic, or metal and have a length from 5 cm to 30 cm and a diameter from 5 to 30 mm and support the pegs and are aligned and fixed to the bars (3), which are made of metal or any polymer or plastic and contain one to twenty pins, with the ends of the bars being inserted into rubber supports (4), which act as shock absorbers and are inserted into the rubber supports (5), which are fixed to the bearing housings (6) in which the ball bearings (7) are contained, which are joined transversely by an eccentric shaft (8) with 1 to 12 mm of eccentricity from the axis that generates all of the circular eccentric movement and have a counterweight to stabilize the movement (9) shaft which, in turn, is fixed at both ends by two bearing housings (10) with ball bearings (11) to the base (12) and has a toothed pulley at one end (13) that is moved by means of a toothed belt (14) and an electric motor (15) which, in turn, transfers the rotational movement to the shafts (8), which transfer the eccentric rotational movement to the bars (3), the pins (2), and the pegs (1), all of which is supported by a base (12), which provides stability to the entire mechanism, which has four wheels (16).

1. An exerciser for restoring flexibility, characterized in that it comprising:
a bed with slots; and
a mechanism with a plurality of pins configured for selective receipt of pegs having flat and rounded heads, the pins being aligned and fixed on at least one bar, with the bar being inserted into at least one rubber support that acts as a shock absorber and, in turn, is inserted into a first bearing housing that has a ball bearing, the first bearing housing joined transversely with at least one eccentric shaft with a counterweight that, in turn, is supported at both ends by at least one second bearing housing with ball bearing, with the eccentric shaft having at one end a toothed pulley that is moved by means of a toothed belt connected to an electric motor, whereby rotational movement of the toothed pulley as driven by the toothed belt and electric motor is transferred to the eccentric shaft, which activates eccentric movement of the bar, the pins, and finally the pegs selectively inserted on the pins and protruding through the slots in the bed, the mechanism being supported by base that, in turn, is supported by a plurality of wheels.

2. (canceled)

3. The exerciser for restoring flexibility as set forth in claim 1, wherein the pins have a diameter from 5 to 30 mm and a length from 5 to 30 cm.

4. The exerciser for restoring flexibility as set forth in claim 1, wherein the pins are made of a polymeric, plastic, or metallic material.

5. The exerciser for restoring flexibility as set forth in claim 1, wherein the pegs cover the support pins with a length from 5 to 30 cm and a diameter from 5 to 30 mm.

6. The exerciser for restoring flexibility as set forth in claim 1, wherein the pegs are made of a polymeric, plastic, or metallic material.

7. The exerciser for restoring flexibility as set forth in claim 1, wherein the bars for supporting the pins are made of metal or any polymer or plastic.

8. The exerciser for restoring flexibility as set forth in claim 1, wherein each bar contains from one to twenty pins.

9. The exerciser for restoring flexibility as set forth in claim 1, wherein the eccentric shaft has 1 to 12 mm of eccentricity in relation to its axis.

10. The exerciser for restoring flexibility as set forth in claim 1, wherein the eccentric shaft is made of metal, polymer, or plastic.

11. The exerciser for restoring flexibility as set forth in claim 1, wherein the mechanism comprises two spaced-apart, substantially parallel eccentric shafts each having a toothed pulley so as to be commonly driven by the toothed belt and electric motor, whereby movement of the two eccentric shafts is substantially synchronized and load balanced with any variance taken up by the at least one rubber support positioned between the at least one bar and the first bearing housing.

12. The exerciser for restoring flexibility as set forth in claim 1, wherein the pegs are configured as one of straight, V-shaped or T-shaped.

13. The exerciser for restoring flexibility as set forth in claim 1, wherein the at least one bar has a substantially square profile so as to prevent rotation of the at least one bar relative to the first bearing housing.

14. An exerciser for restoring flexibility comprising:
a bed with slots; and
a mechanism with a plurality of pins configured for selective receipt of pegs, the pins being aligned and fixed on at least one bar, with the bar being inserted into at least one rubber support that acts as a shock absorber and, in turn, is inserted into a first bearing housing that has a ball bearing, the first bearing housing joined transversely with at least one eccentric shaft that, in turn, is supported at both ends by at least one second bearing housing with ball bearing, whereby rotational movement of the eccentric shaft activates eccentric movement of the bar, the pins, and finally the pegs selectively inserted on the pins and protruding through the slots in the bed.

15. The exerciser for restoring flexibility as set forth in claim 14, wherein the mechanism is supported by a base that, in turn, is supported by a plurality of wheels.

16. An exerciser for restoring flexibility comprising:
a bed with slots; and
a mechanism with a plurality of pins configured for selective receipt of pegs, the pins being aligned and fixed on at least one bar, with the bar being coupled with a first bearing housing that has a ball bearing, the first bearing housing joined transversely with at least one eccentric shaft with a counterweight that, in turn, is supported at both ends by at least one second bearing housing with ball bearing, with the eccentric shaft having at one end a toothed pulley, whereby rotational movement of the toothed pulley as driven by a toothed belt and an electric motor is transferred to the eccentric shaft, which activates eccentric movement of the bar, the pins, and finally the pegs selectively inserted on the pins and protruding through the slots in the bed.

17. The exerciser for restoring flexibility as set forth in claim 16, wherein the at least one bar is inserted into at least one rubber support that acts as a shock absorber and, in turn, is inserted into the first bearing housing.

18. The exerciser for restoring flexibility as set forth in claim 16, wherein the mechanism is supported by a base that, in turn, is supported by a plurality of wheels.

19. An exerciser for restoring flexibility comprising:
a bed with slots; and
a mechanism with a plurality of pins, the pins being aligned and fixed on at least one bar coupled with a first bearing housing configured to receive a shaft having at one end a toothed pulley that is moved by means of a toothed belt connected to an electric motor, whereby rotational movement of the toothed pulley as driven by the toothed belt and electric motor is transferred to the shaft, which activates movement of the bar and the pins, the mechanism being supported by a base independent of the bed.

20. The exerciser for restoring flexibility as set forth in claim 19, wherein:
the shaft is configured as at least one eccentric shaft with a counterweight; and
the first bearing housing is joined transversely with the at least one eccentric shaft that, in turn, is supported at both ends by at least one second bearing housing.

21. The exerciser for restoring flexibility as set forth in claim 19, wherein;
the pins are configured for selective receipt of pegs having flat and rounded heads;
the at least one bar is inserted into at least one rubber support that acts as a shock absorber and, in turn, is inserted into the first bearing housing; and
two spaced-apart, substantially parallel eccentric shafts are provided each having a toothed pulley so as to be commonly driven by the toothed belt and electric motor, whereby movement of the two eccentric shafts is substantially synchronized and load balanced with any variance taken up by the at least one rubber support positioned between the at least one bar and the first bearing housing.
